(19) United States
(12) Patent Application Publication
(10) Pub. No.: US 2026/0268330 A1
(43) Pub. Date: Sep. 10, 2026

(54) PREVENTING FRAUDULENT ROLLBACK OF A TRUSTED APPLICATION

(71) Applicant: CRUNCHFISH DIGITAL CASH AB, Malmo (SE)

(72) Inventors: Joachim SAMUELSSON, Helsingborg (SE); Paul CRONHOLM, Malmo (SE)

(21) Appl. No.: 19/165,797

(22) PCT Filed: Mar. 18, 2024
(86) PCT No.: PCT/SE2024/050245

§ 371 Date: Sep. 16, 2025

(30) Foreign Application Priority Data
Mar. 16, 2023 (SE) 2350296-6

(51) Int. Cl. G06Q 20/40; G06Q 20/32; G06Q 20/38

(52) U.S. Cl. CPC G06Q 20/4016; G06Q 20/327; G06Q 20/3825

(57) ABSTRACT

A method (500) of preventing fraudulent rollback of a trusted application (TA) involving repeatedly recording (510) an execution state of the trusted application (TA); repeatedly causing (520) recording of the execution state in an entity external to the trusted application (TA); upon occurrence of an event in the trusted application (TA), sending (530) a request (Sec_Update_Req, Issuer_Update_Req; Device_SE_Sign_Req) to said external entity; receiving (540) a response (Issuer_Update_Resp; Device SE_Sign_Resp, Sec_Update_Resp) to said request including information which enables verification by the trusted application (TA) that a present execution state within the trusted application (TA) is not older than a most recent execution state as recorded by the external entity; and controlling (550) access to the protected asset (ta asset) depending on an outcome of the verification. The external entity signs the response (Issuer_Update_Resp; Device_SE_Sign_Resp, Sec_Update_Resp) with a private cryptographic key (issuer_priv_key; device_se_priv_key), and the trusted application (TA) verifies the signature.

### TECHNICAL FIELD

The present invention generally relates to digital security. More particularly, the present invention relates to technical improvements to prevent fraudulent rollback of a trusted application executable in a secure execution environment of a host device. Even more particularly, the present invention relates to a method, host device, trusted application, computerized backend resource and computer readable storage media for such prevention of fraudulent rollback.

### BACKGROUND

Digital security is a collective term for the protection of functionality and data from unwarranted information disclosure, theft or damage. Digital security broadly relates to the protection of hardware, software and data. A host device, also known as a network host, is a hardware device being adapted to communicate with other hosts on a network. Host devices in a network may include clients and servers that send or receive data, services or applications.

In line with the rapidly expanding information technology development of the recent decades, software is consistently becoming more and more complex. It is not uncommon that software projects can comprise millions of lines of code. A downside of this is that every line of code could potentially be associated with a bug caused by, for instance, a programming error. Each bug is a potential attack vector for e.g. a person or script with malicious intent. Clearly, different bugs may expose different security vulnerabilities. Some bugs can easily be detected, while others are not so easily identified. Operating system kernel bugs are particularly crucial to manage, because if bugs are exploited in the kernel there is a risk of compromising the security of the entire system.

In order to securely execute protected functionality and data within the host device, the host device is thus commonly configured with a variety of different computerized security arrangements. Security arrangements may serve different purposes, wherein one purpose is to manage execution privileges of certain protected functionality and data. The protected functionality and data may be maintained in various physical or virtual locations of the security arrangement. Known security arrangements in the art typically involve hardware-based protection, software-based protection, or combinations, for providing a secure execution environment for the protected functionality and data.

Hardware-based protection involves partitioning a traditional kernel execution environment into two separate and respectively isolated execution environments, commonly referred to as a rich execution environment, REE, and a trusted execution environment, TEE. The TEE provides security features that isolate the integrity of applications executing within the TEE, along with confidentiality of their resources. Applications being executed in the TEE are therefore typically associated with a higher level of security compared to applications being executed in the REE. Hence, the applications being executed in the TEE are commonly being referred to as trusted applications. Although trusted applications are running in the TEE, they will still need to access protected functionality and data maintained by hardware resources. Accordingly, the requested hardware is typically supported by various hardware support which assures that the trusted applications can securely access the protected hardware resources.

Software-based protection involves providing a virtual execution environment within the software of the host device. The trusted applications are only allowed to be executed in the virtual execution environment, and they are configured to access protected functionality and data in the protected hardware resources.

Even if one of the security arrangements mentioned above are in place, the host device may still be prone to one or more security vulnerabilities.

Particularly, security vulnerabilities may be exposed when rollback of a trusted application is performed. Rollback involves techniques to reinstall a trusted application in a historic execution state, wherein a protected asset of the trusted application is “rewound” to a previous state older than a current state. The protected asset may, for instance, be a balance of a local digital wallet.

One security vulnerability that rollback of a trusted application may open up to is related to the double-spending problem. The double-spending problem may occur for a local digital wallet being executed as a trusted application in a secure execution environment. If the roll-backed trusted application continues to operate in an offline mode for which no instant online payment verification can be made, digital currency can be consumed from the local digital wallet that has already been consumed once, i.e. before the rollback of the trusted application. The same digital currency is thus consumed twice, i.e. double-spending. Related security vulnerabilities may occur where, as a result of a rollback of a trusted application, a protected asset that represents a finite digital resource such as a service subscription or a license scheme is made possible to use more than once for the same specific action, without that being the intention of a stakeholder of the protected asset.

### SUMMARY

In line with the observations above, the present inventors have made valuable technical insights to solve or at least mitigate one or more of the challenges referred to in the previous section. These insights will be presented as inventive aspects in the detailed description section and the drawings. The list of inventive aspects is not to be seen as exhaustive but rather a summary of particularly beneficial inventive aspects. Generally, all terms used herein are to be interpreted according to their ordinary meaning in the technical field, unless explicitly defined otherwise herein.

A first inventive aspect is a method of preventing fraudulent rollback of a trusted application executable in a secure execution environment of a host device, the trusted application comprising a protected asset, the method involving: repeatedly recording an execution state of the trusted application within the trusted application, the execution state being a monotonic function of execution progress of the trusted application; repeatedly causing recording of the execution state in an entity external to the trusted application; upon occurrence of an event in the trusted application, sending a request to said external entity; receiving a response to said request from said external entity, the response including information which enables verification by the trusted application that a present execution state within the trusted application is not older than a most recent execution state as recorded by the external entity; and controlling access to the protected asset depending on an outcome of the verification, wherein the external entity signs the response the trusted application with a private cryptographic key kept secret by the external entity, and wherein the trusted application verifies the signature of the response using a public cryptographic key corresponding to the private cryptographic key as part of the verification by the trusted application.

A second inventive aspect is a host device comprising a secure execution environment for executing a trusted application, the trusted application comprising a protected asset, the host device being configured to prevent fraudulent rollback of the trusted application by performing the functionality of the method according to the first inventive aspect.

A third inventive aspect is a trusted application comprising computer program code being executable in a secure execution environment of a host device, the trusted application comprising a protected asset and being configured to prevent fraudulent rollback by performing the functionality of the method according to the first inventive aspect.

A fourth inventive aspect is a computerized backend resource for preventing fraudulent rollback of a trusted application executable in a secure execution environment of a host device, the trusted application comprising a protected asset, the computerized backend resource being configured to perform the functionality of the computerized backend resource in the method according to the first inventive aspect.

Further inventive aspects are non-transitory computer readable storage media, each having stored thereon a computer program comprising computer program code for performing the functionality of the host device, the trusted application, and the computerized backend resource, respectively, in the method according to the first inventive aspect.

Other aspects, objectives, features and advantages of the inventive aspects will appear from the following detailed disclosure as well as from the claims and the drawings. Generally, all terms used herein are to be interpreted according to their ordinary meaning in the technical field, unless explicitly defined otherwise herein.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

Expressions like “[something] is configured for . . . [performing activity]” or “[something] is configured to . . . [perform activity]” will include typical cases where a computerized “something” (having one or more controllers, processing units, programmable circuitry, etc.) executes software or firmware installed in the computerized “something”, wherein the execution occurs in order to perform the activity in question.

### BRIEF DESCRIPTION OF THE DRAWINGS

The foregoing will be apparent from the following more particular description of the example embodiments, as illustrated in the accompanying drawings. The drawings are not necessarily to scale, emphasis instead being placed upon illustrating the example embodiments.

FIG. 1A is a schematic block diagram of a host device running a trusted application in a secure execution environment being a software-based virtual execution environment according to an embodiment.

FIG. 1B is a schematic block diagram of a host device running a trusted application in a secure execution environment being a software-based virtual execution environment according to another embodiment.

FIG. 2 is a schematic flowchart diagram illustrating a method of preventing fraudulent rollback of a trusted application according to an embodiment.

FIG. 3 is a schematic flowchart diagram illustrating a method of preventing fraudulent rollback of a trusted application according to another embodiment.

FIG. 4 is a schematic block diagram of a digital payment system, the security of which may be improved thanks to the present disclosure.

FIG. 5 is a schematic block diagram of a method of preventing fraudulent rollback of a trusted application according to an embodiment.

FIG. 6 is a schematic illustration of a non-transitory computer-readable storage medium in one exemplary embodiment, capable of storing a computer program product.

### DETAILED DESCRIPTION OF EMBODIMENTS

Inventive aspects and embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like reference signs refer to like elements.

The following disclosure is related to prevention of fraudulent rollback of a trusted application. The disclosure employs a security scheme utilizing dual counters, or other monotonically progressing functions, in both a trusted application and an external entity to track execution states, thereby preventing fraudulent rollbacks by ensuring sequential integrity of operations. Additionally, the use of digital signing based on asymmetric cryptographic keys allows the external entity to securely sign response messages with a private key, while the trusted application verifies these using the corresponding public key. This approach provides advantages over other methods employing symmetric encryption as it offers non-repudiation, which eliminates the need to securely share and manage a common secret key, simplifies key distribution given that public keys can be openly shared, and reduces the risk of key compromise since the private key never needs to leave the secure confines of the external entity. A layered security approach is thus provided in which the counters (or other monotonically progressing functions) ensure the integrity of the transaction sequence, while the digital signing based on asymmetric cryptographic keys secures the integrity of the communication channel between the trusted application and the external entity. The counters (or other monotonically progressing functions), maintained by both the trusted application and the external entity, act as a safeguard against replay attacks and unauthorized rollbacks by verifying that each transaction follows the correct order. Digital signing based on asymmetric cryptographic keys, on the other hand, offers advantages over symmetric encryption by facilitating secure message signing and verification through the use of a private/public key pair, enhancing trust and security without the need to manage and exchange shared secrets. This combination of security measures not only secures the transaction process but also strengthens the authentication of the entities involved.

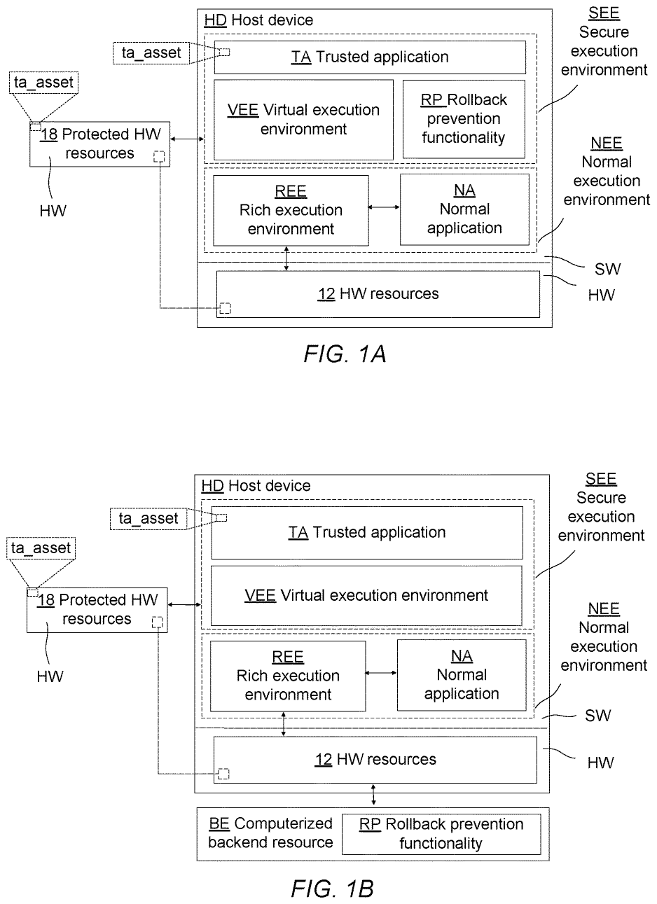

As seen in FIG. 1A, a host device HD is configured for running a trusted application TA. The trusted application TA is executable in a secure execution environment SEE of the host device HD. The host device HD may be a mobile communication device, such as a mobile phone, smart phone, tablet computer, personal digital assistant, smart glasses, smart watch, smart card or smart wearable (e.g. smart bracelet), or any combination thereof. The host device HD may alternatively be any type of computer device capable of securely executing protected functionality and data.

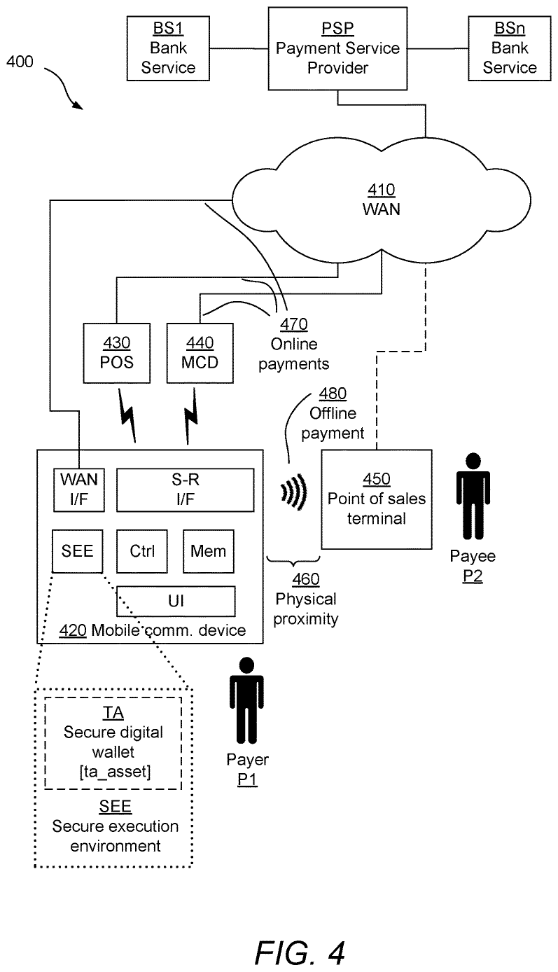

The trusted application TA may support offline digital payments communicated by short-range wireless communication between the host device HD acting as a payer device and an external communication device acting as a payee device. This will be further detailed with reference to FIG. 4 in the present disclosure.

The host device HD implements a computer architecture scheme that is partitioned into two separate and respectively isolated execution environments, the environments being a normal execution environment NEE and a secure execution environment SEE. Execution of the trusted application TA involves separating it from the normal execution environment NEE and maintaining it in the secure execution environment SEE. The secure execution environment SEE is a secure world in the sense that the trusted application TA can be executed in a secured virtual execution environment VEE. The trusted application TA is thus protected by software. The virtual execution environment VEE is adapted to access and execute protected functionality and data which is maintained in protected hardware resources. Any suitable virtual execution environment technologies known in the art may be implemented. For instance, the virtual execution environment VEE may be implemented generally according to subject-matter disclosed in the European patent EP 2 795 829 B1.

The normal execution environment NEE is a non-secure world in the sense that one or more untrusted “normal” applications NA can be executed in a rich execution environment REE of the normal execution environment NEE. The rich execution environment REE is adapted to run any type of embedded operating system or a general-use operating system, such as Android, iOS, Linux or Windows. The rich execution environment REE may access the normal applications NA through one or more application programming interfaces (APIs). The normal applications NA may thus be any type of web, native or hybrid applications being provided by an application service provider that is not trusted by the host device HD. The rich execution environment REE is adapted to access hardware resources (including firmware resources) 12 of the host device HD through, for instance, a hypervisor (not shown). Hardware resources 12 may include processing units, memories (e.g. DRAMs), data storages, drivers, and so forth.

A normal application NA may require secure support from a trusted application TA. An example of this may be a payment application service (normal application NA) being in communication with a secure digital wallet (trusted application TA). One example of a digital payment system for such purposes will be described later with reference to FIG. 4.

The secure execution environment SEE is a secure world in the sense that the trusted application TA can be executed in a trusted way. The secure execution environment SEE is adapted to access and execute protected functionality and data which are maintained by protected hardware resources 18, e.g. memories, data storages, buses, peripherals, memory regions, interrupts, and so forth. The secure execution environment SEE may be implemented in any trusted execution environment technology known in the art, including but not limited to Samsung TEEGRIS, Qualcomm TEE, Huawei iTrustee, Trustonic Kinibi, Google Open Source Trusty, Open Portable TEE, Nvidia's Trusted Little Kernel for Tegra, Sierra TEE, ProvenCore TEE, Trusty TEE for Android, or TrustKernel T6. The protected hardware resources 18 may be protected by any hardware support technologies known in the art, including but not limited to Arm's TrustZone, MultiZone Security, AMD Platform Security Processor, Intel Software Guard Extensions, Apple's Secure Enclave Processor, or Google's Titan M.

FIG. 1A also illustrates a rollback prevention functionality RP. The rollback prevention functionality RP serves as a safeguard mechanism aimed at mitigating potential risks associated with reverting to previous versions of software or firmware updates. The rollback prevention functionality RP may prevent re-use of a protected asset (see description of ta_asset below) for a specific action that has already been performed once before. The rollback prevention functionality RP involves a plurality of security, timing, counter and/or version compatibility checks to verify the integrity and authenticity of the software being installed. To this end, issues stemming from outdated software on new configurations may be prevented. The rollback prevention functionality RP accordingly attempts to address one or more of the problems raised in the background section of the present disclosure.

In the example of FIG. 1A, the rollback prevention functionality RP is configured within the secure execution environment SEE of the host device HD. The arrangement within the secure execution environment SEE provides an isolated space where sensitive operations can take place away from the main operating system. This isolation may protect the rollback prevention functionality RP from being tampered with by malware or other malicious processes that might have compromised the host environment. Moreover, rollback prevention mechanisms can be shielded from unauthorized modifications. This may ensure that the integrity of the rollback process and its associated data (like snapshots or logs) is maintained, which can be important for reliable restoration. Additionally, by placing rollback protection in the secure execution environment SEE, such unauthorized attempts of forcing a system rollback to an earlier, more vulnerable state where security patches have not been applied can be thwarted. This is due the secure execution environment SEE being able to enforce strict access controls and authentication procedures. Yet additionally, in the event of an attack or system compromise, services and security features within the secure execution environment SEE can remain available, providing a resilience which allows the system to perform possible necessarily rollbacks to safe states, even if the primary operating system is compromised. Furthermore, the secure execution environment SEE can oversee the process of applying updates and patches, ensuring that new changes can be authenticated and verified before they are applied. If an update fails verification, the rollback protection can revert the system to a secure state before the update was applied. The configuration of the rollback prevention functionality RP within the secure execution environment SEE may also offer tamper-evident records of rollback-related activities, which may be important for forensic analysis and compliance with security policies. In addition, rollback protection in the secure execution environment SEE can be an integral part of a secure boot process, maintaining a chain of trust from the system's startup to normal operation. This may prevent attackers from rolling back the system to a state with compromised boot loaders or firmware.

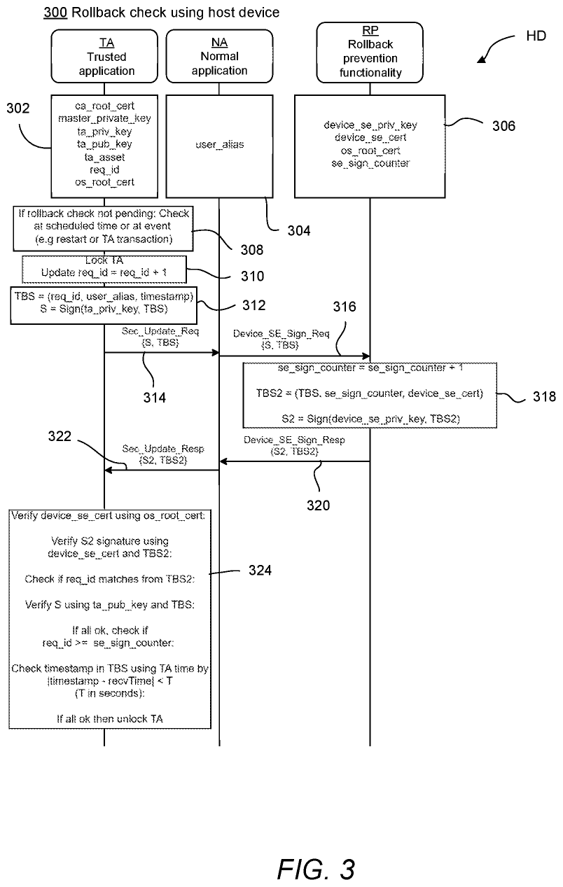

The rollback prevention functionality RP may be maintained by a secure element (SE, a reference which will also be seen in FIG. 3) instance. The secure element may be a hardware module designed to provide a dedicated, tamper-resistant environment for secure storage and processing. The secure element may also extend to software-based implementations (such as the TEEs described above) that aim to emulate some of the security characteristics of hardware secure elements.

Further seen in FIG. 1A is a protected asset (ta_asset). The protected asset refers to any sensitive piece of information or critical functionality that requires additional security measures to prevent unauthorized access or manipulation. The protected asset may represent a finite digital resource, such as a service subscription or a license scheme. The protected asset may alternatively include encryption keys used to secure communications, authentication credentials, financial data, health records, biometric data, digital certificates, digital rights management control data, system and network configurations, operational data, corporate data, legal documents, source code and software artefacts, government classified information, research data, communication logs, access control lists, emergency recovery protocols, intellectual property, proprietary algorithms, personal user data, or any other type of data that is considered confidential and valuable. The protected asset is comprised by the trusted application TA, and can be maintained in different locations as seen in the exemplary illustration. Generally, the computing environment may be configured to maintain one or more protected assets at one or more computerized locations. In this very example protected assets are maintained directly by the trusted application TA and by the protected hardware resources 18. In the context of the trusted application TA operating within the secure execution environment SEE, the protected asset is shielded by robust security protocols and access controls that ensure only authorized code or users can interact with or access it. However, these security protocols and access controls fails to prevent fraudulent rollback of the trusted application TA to an earlier state where the protected asset can be exploited. In some embodiments, the protected asset is stored encrypted in the protected hardware resources 18 and loaded into the trusted application TA at runtime. In some embodiments, the protected hardware resources 18 are part of the same physical structure as the hardware resources 12.

With further reference to FIG. 1B, another exemplary block diagram is shown. This example differs from the one in FIG. 1A by a computerized backend resource BE configured with the rollback prevention functionality RP.

The host device HD is in communication with the computerized backend resource BE. The computerized backend resource BE may, for instance, be a trusted third party. Communication between the host device HD and the backend resource BE may be via a cloud network (such as, for instance, WAN network 410 in FIG. 4), or alternatively any other suitable types of long-range or short-range communication standards known in the art. For instance, short-range communication interfaces include, for instance, IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, or any other form of proximity-based device-to-device radio communication signal such as LTE Direct. Long-range communication interfaces may include, for instance, W-CDMA/HSPA, GSM, UTRAN, LTE or Starlink.

The backend resource BE may be maintained as a cloud-based server implemented using any commonly known cloud-computing platform technologies, such as e.g. Amazon Web Services, Google Cloud Platform, Microsoft Azure, DigitalOcean, Oracle Cloud Infrastructure, IBM Bluemix or Alibaba Cloud. The cloud-based server may be included in a distributed cloud network that is widely and publically available, or alternatively limited to an enterprise. Alternatively, the server may in some embodiments be locally managed as e.g. a centralized server unit. Other alternative server configurations may be realized, based on any type of client-server or peer-to-peer (P2P) architecture. Server configurations may thus involve any combination of e.g. web servers, database servers, email servers, web proxy servers, DNS servers, FTP servers, file servers, DHCP servers, to name a few.

Communications between the trusted application TA and the computerized backend resource BE may involve circuit-switched telecommunications.

The trusted application TA may support actions that operate upon the protected asset (ta_asset) and involves packet-switched wide area network communication with the computerized backend resource BE.

The rollback prevention functionality RP is configured with the computerized backend resource BE as opposed to the example of FIG. 1A where the rollback prevention functionality RP was configured with the secure execution environment SEE. Positioning the rollback prevention functionality RP within a computerized backend resource BE offers the advantage of leveraging a specialized and secure infrastructure that is distinct from the host device HD. This separation can provide a safeguard against local threats, ensuring that the rollback prevention functionality RP remains uncompromised even if the host device HD is infiltrated by malware or other security breaches. The computerized backend resource BE can act as a custodian, maintaining the integrity and availability of the rollback data, such as backups and logs, which are crucial for the restoration process. Additionally, the computerized backend resource BE can implement stringent security protocols and access controls, effectively preventing unauthorized rollback attempts that aim to revert the system to a less secure, pre-patch state. This level of security is maintained due to the advanced capabilities of the trusted third party in enforcing these controls, which might exceed the host device's inherent security measures. In the event of an attack or system compromise, the computerized backend resource BE can ensure continuity of the rollback protection services, allowing for necessary rollbacks to be performed without being hindered by the compromised state of the host device HD. The computerized backend resource BE can also manage the update and patch verification processes, authenticating and vetting changes before they are implemented. Should an update not meet the required security standards, the computerized backend resource BE can be equipped to revert the system back to a secure state prior to the update attempt. Furthermore, by entrusting the rollback prevention functionality RP to the computerized backend resource BE, organizations can benefit from specialized expertise and scalable infrastructure capable of handling an expanding array of host devices. Compliance with security policies and the generation of tamper-evident audit trails for forensic analysis further reinforce the rationale behind utilizing a computerized backend resource BE for managing rollback prevention functionalities RP. The backend arrangement can thus complement the secure execution environment SEE by providing a resilient and robust framework for rollback prevention, maintaining system integrity from the initial boot sequence throughout the system's operational life cycle.

In some other examples not explicitly shown, parts of the rollback prevention functionality RP can optionally be arranged in the secure execution environment SEE while other parts of the rollback prevention functionality RP can be arranged in the computerized backend resource BE.

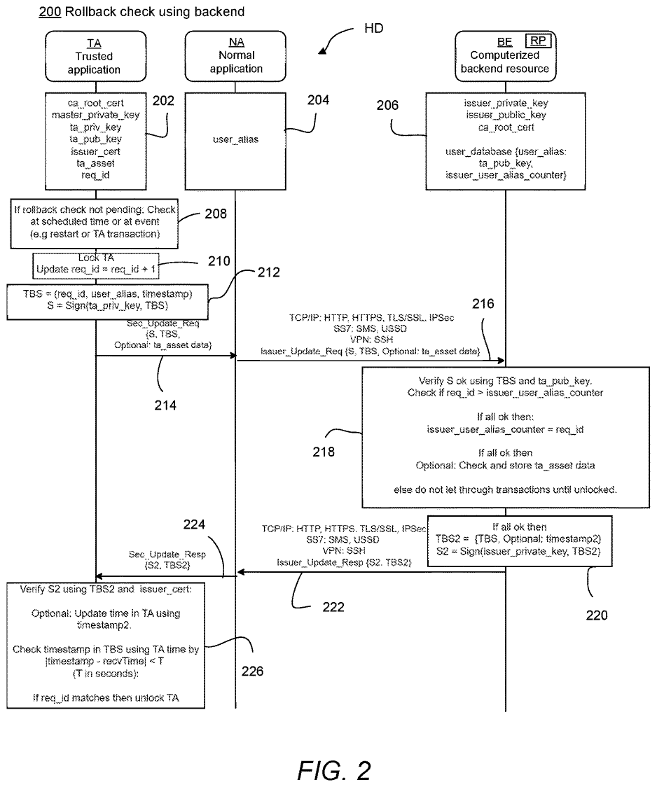

Examples of the operation of a mobile payment application will now be described with further reference to FIGS. 2-3. FIG. 2 shows a procedure 200 of rollback check using the computerized backend resource BE (similar to FIG. 1B), while FIG. 3 shows a corresponding procedure 300 of rollback check using the host device (similar to FIG. 1A), such as a secure element. Both of these exemplary flowchart diagrams illustrate methods of preventing fraudulent rollback of a trusted application TA. It shall be noted that these embodiments are merely implementation examples of the more general inventive aspects, and shall not be viewed as limiting to the scope of the present disclosure. Moreover, it shall be understood that embodiments, examples or variations explained with respect to a certain flow (for example that of FIG. 2) are generally also applicable for the other flow (for example that of FIG. 3) unless the opposite is explicitly stated.

In the procedures 200, 300 three entities take part in the rollback checks. In both of the procedures 200, 300, the first and second entities are the normal application NA and the trusted application TA. The normal application NA is in these examples the mobile payment application. In order to perform a payment operation, the normal application NA is running together with the trusted application TA. The trusted application TA may be a secure digital wallet. A mechanism for communication between the normal execution environment NEE and the secure execution environment SEE is therefore solicited by the host device HD. Accordingly, the normal application NA goes through a process to load and communicate with the trusted application TA corresponding to the secure digital wallet. The trusted application TA is located within the secure execution environment SEE and communication thereto can be established through specific communication channels and APIs available to both the normal execution environment NEE and the secure execution environment SEE. Details of the respective flowchart diagrams will now be further explained.

In FIG. 2, the third entity of the procedure 200 is the computerized backend resource BE. To this end, the rollback prevention functionality RP is comprised in the computerized backend resource BE, corresponding to the embodiment shown in FIG. 1B. The aforementioned external entity is therefore in this embodiment the computerized backend resource BE, or optionally some execution environment maintained therein. The computerized backend resource BE may additionally or alternatively be referred to as an issuer in terms of digital payment systems. The issuer refers to a financial institution or entity being responsible for managing payment-related data, including but not limited to credit or debit cards, account data, authorization data, security data, statement data, compliance data, etc. Embodying the external entity as the computerized backend resource BE to prevent fraudulent rollback in a system may provide security enhancements and maintenance of the integrity of critical operations, especially in contexts like financial transactions. By leveraging the computerized backend resource BE which typically includes robust security measures already in place, such as secure audit trails, encryption, and strict access controls, a more resilient defense against potential malicious activities can be provided. The computerized backend resource BE may provide an immutable audit trail, making it difficult for attackers to tamper with transaction history. It may also add an extra layer of protection by securing critical data independently of local system vulnerabilities.

In this external communication scenario, the computerized backend resource BE typically authenticates itself to the host device HD using its own certificates, and the host device HD does the same in return. These certificates are part of a broader PKI system that is independent of the root certificate of the operating system. This external PKI system ensures secure communication between the host device and the backend resource, allowing them to establish a trusted channel without relying on the internal OS root certificate. Therefore, when interfacing with the computerized backend resource BE, trust is established through an external PKI system, which uses certificates that are mutually recognized by both parties, thus eliminating the need for an OS root certificate of the host device HD in the communication process. A certificate, as defined herein, encompasses a public cryptographic key being the second part of a PKI pair. The first part is the private key held by the communicating entity. This certificate allows secure communication, and the requests are signed using the private key of the other entity.

At 202, 204 and 206 various data to be used for the procedure 200 are shown. These may be set during initiation of the procedure 200, and/or were optionally set at a previous operation.

Seen at 202 is data maintained by the trusted application TA. The data includes root certificate ca_root_cert. The root certificate ca_root_cert is issued by a trusted Certificate Authority (CA) and serves as the foundational trust anchor in a public key infrastructure, validating the authenticity of subordinate certificates to establish secure communication and verify the identity of entities in online transactions. The data further includes a master private key master_private_key. The master private key master_private_key is held by the trusted application TA to generate and control other cryptographic keys within the computer environment. The data further includes a keyset involving a trusted application private key ta_priv_key and a trusted application public key ta_pub_key. The trusted application private key ta_priv_key is used for generating digital signatures that can be verified by others using the corresponding trusted application public key ta_pub_key. The trusted application private key ta_priv_key is also used to decrypt information that has been encrypted with the corresponding trusted application public key ta_pub_key. The data further includes a certificate issuer_cert issued by the CA to verify the authenticity and legitimacy of entities issuing their own certificates. The protected asset ta_asset refers to valuable resource or information safeguarded through various security measures to prevent unauthorized access or modification. The data also includes a first counter req_id. The purpose of the first counter req_id is to repeatedly be able to record an execution state after some events occurring, which will be described in more detail at 210. The first counter req_id may be an integer value incrementable by one at a time, or alternatively some other value capable of being incremented similar to an integer value.

Seen at 204 is data maintained by the normal application NA, including a user alias user_alias. The user alias user_alias may be a chosen or assigned alternative identity used by a user to interact with the normal application NA, typically used for identification, privacy or customization purposes.

Seen at 206 is data maintained by the computerized backend resource BE. The data includes an issuer PKI keyset involving an issuer private key issuer_private_key and an issuer public key issuer_public_key. The data includes a CA root certificate ca_root_certificate issued by a trusted authority, forming the basis of trust for certificates issued by that CA, including those used in the digital payment system. The data also includes a user database of user information. More specifically, the user information includes, for each user alias, a trusted application public key ta_pub_key and a second counter issuer_user_alias_counter. The second counter issuer_user_alias_counter involves a similar purpose as the first counter value req_id maintained by the trusted application TA. The second counter issuer_user_alias_counter may be an integer value incrementable by one at a time, or alternatively some other value capable of being incremented similar to an integer value. The purpose of the second counter issuer_user_alias_counter is to repeatedly be able to record an execution state, for example after some events occurring, which will be described in more detail at 218.

Once the data is established the rollback check procedure 200 proceeds at 208, involving an check whether there is a pending rollback procedure. If this is not the case (i.e. no ongoing rollback procedure) the rollback check continues. The rollback check may be performed at scheduled times, such as certain time intervals. Alternatively, the rollback check may be performed in response to specific events occurring, such as system restarts or the completion of transaction within the trusted application TA. In cases where an ongoing rollback procedure is detected, preventive actions may be taken. For example, the rollback procedure 200 may be halted to prevent the system from reverting to a vulnerable state, a security administrator or master unit can be alerted about the suspicious activity, and potentially initiating further security checks or audits to assess the integrity of the application and its data, the state of the system may be updated to a secure baseline or the latest known valid configuration and blocking transactions until the issue is resolved. This may be complemented with initiating a new request or causing retransmission of the first request with an updated timestamp value.

At 210, the trusted application TA is locked. Step 210 follows a successful check that a rollback procedure is not pending from 208. Locking the trusted application TA before a sequence of events is done for purposes of maintaining data integrity, preventing race conditions, ensuring transaction isolation, and enhancing security by controlling access to critical sections of code or data, thereby preventing potential conflicts and unauthorized operations in e.g. multi-threaded environments. In addition, at 210 an execution state of the trusted application TA is recorded. In the present example the execution state is recorded by incrementing the first counter req_id, for example by one (1) or more (>1).

The execution state of the trusted application TA refers to a representation of the current point in the program's operation or progress within the trusted application TA itself. This state is used to track where the trusted application TA is in its sequence of tasks or operations. When described as a monotonic function of execution progress, it implies that the execution state is a value or set of values that consistently increases (or possibly decreases, but usually increases) in one direction as the trusted application TA progresses. It does not decrease or loop back on itself, which is what makes it monotonic. This concept ensures that each state of the trusted application TA is unique and follows a predictable, one-way progression. This is used for purposes of ensuring that transactions or operations are performed in the correct order, for validating the sequence of events, and for preventing attacks, such as fraudulent rollback attacks, where an adversary might attempt to roll back the present state to one or more previous states to disrupt the operation of the trusted application TA.

While the present example implements the above by way of the two distinct counters req_id, issuer_user_alias_counter, it shall be understood that variations may be applicable. Other variations to implement this monotonic function of the execution progress may involve timestamps, commit logs, distributed ledgers, versioning, digital signatures with sequence information, or the like.

At 212, a request to be signed TBS is defined which includes the incremented first counter req_id, the user alias user_alias of the user associated with the normal application NA, and a timestamp value timestamp. Although not explicitly shown, the request TBS may also include a nonce for uniquely identifying the request TBS and assisting in confirming that the request TBS is both current and has not been previously submitted. The timestamp timestamp is a temporal marker indicating e.g. date and time of a specific event or the receipt of a message to facilitate synchronization, logging, or confirmation. The request TBS is then signed S with the private key of the trusted application ta_priv_key. Signing the request may offer one or more technical advantages, similar to the signing of the response which will be described to some extent when referencing step 220 shortly. While such signing in step 212 is believed to be beneficial as just explained, it may be optional in the sense that there may be other embodiments for which no such signing takes place.

At 214, the request S is transmitted as Sec_Update_Req to the normal application NA together with the request TBS. Both a signed S and non-signed TBS version of the request is sent to allow the receiving entity (in this case the computerized backend resource BE) to easily verify the integrity and authenticity of the message using the signed version, while utilizing the non-signed version for processing the actual request content without the need for additional extraction steps. Optionally, the transmission also involves the data pertaining to the protected asset ta_asset. The data pertaining to the protected asset ta_asset may be necessary for certain operations, such as providing legitimate transactions, thereby enabling the normal application NA to process and provide relevant services while adhering to e.g. security protocols.

The request Sec_Update_Req is sent upon an occurrence of an event in the trusted application TA. The event may indicate a change that can possibly involve an attempt to perform fraudulent rollback, thereby necessitating the need for a check to verify whether this is the case. By way of example, the event is one or more of a rebooting of the host device HD, a request for an action that operates upon the protected asset ta_asset (such as a read/write request etc.), an occurrence of a scheduled event (such as automated task or process relating to system maintenance, data backup or script/program execution, etc.), a randomized occurrence of an event (such as interest rate changes, defaults on loans/bonds, uncertainty factor in algorithms, sampling, controlled trial, game event, number generation, etc.).

At 216, the normal application NA routes the request Sec_Update_Req to the computerized backend resource BE, now referred to as the request Issuer_Update_Req. The illustration presents some exemplary communication protocols that may be used for assuring that the request Issuer_Update_Req is not tampered with. Some non-limiting examples shown in FIG. 2 are TCP/IP (HTTP, HTTPS, TLS/SSL, IPSec), SS7 (SMS, USSD), and VPN (SSH).

At 218, the computerized backend resource BE receives the request Issuer_Update_Req from the normal application NA. The computerized backend resource BE verifies that the request Issuer_Update_Req conforms to predefined criteria, security protocols, business rules, or the like. This is done using the received request Issuer_Update_Req and the public key of the trusted application ta_pub_key maintained by the computerized backend resource BE. Before any additional action is taken, step 218 also involves a check to verify that the first counter req_id is greater than the second counter issuer_user_alias_counter. If the request Issuer_Update_Req is verified and the counter check is passed, the value of the second counter issuer_user_alias_counter is set to the same value as the first counter req_id. This accordingly causes a recording of the execution state external to the trusted application TA (as it occurs at the computerized backend resource BE in addition to at the trusted application TA). In the optional example where the request Sec_Update_Req, Issuer_Update_Req involves data pertaining to the protected asset ta_asset, said data is verified and stored by the computerized backend resource BE for further operation. If any of the conditions are not met, i.e., one of the signed request Sec_Update_Req, Issuer_Update_Req cannot be accurately verified for some reason, or the value of the second counter issuer_user_alias_counter is not greater than the first counter req_id (for example it may instead be equal to or less than), all pending or future transaction are interrupted. Hence, distinct from the corresponding step 318 of FIG. 3 which will be described later on with reference thereto, the second counter issuer_user_alias_counter is used by the computerized backend functionality BE to verify that the present execution state within the trusted application TA is not older than the most recent execution state as recorded by the computerized backend resource BE.

Step 218 is done to mitigate the risk of unauthorized changes or the execution of potentially harmful transactions. As such, a conservative approach is taken involving said interruption, serving as an immediate stop to any further actions that could compromise the system until the issue is resolved. This is accordingly a protective measure designed to maintain the security posture and ensure that any operations involving the protected asset ta_asset are conducted in a secure and controlled manner. In summary, the interruption of transactions is a precautionary response to any anomalies detected during the verification process, reflecting a principle of “security first” to prevent potential damage or exploitation of the system.

In this very example the first counter req_id was thus incremented in preparation of the sending of the request at steps 214, 216. Moreover, the second counter issuer_user_alias_counter was incremented between the receiving of the request Sec_Update_Req, Issuer_Update_Req and the sending of a response by the computerized backend resource BE acting as the external entity.

The flowchart illustration continues at 220 in the case where the signed request Sec_Update_Req, Issuer_Update_Req and the value of the second counter issuer_user_alias_counter is as expected according to the above. At 220, a response to be signed TBS2 is defined. The response TBS2 includes the request TBS and optionally another timestamp timestamp2. The response TBS2 is signed to S2 similarly to the request TBS, but using the private key of the issuer issuer_private_key instead.

Using the digital signing based on asymmetric cryptographic keys in this context, where the external entity signs the response with a private key and the trusted application TA verifies it with the corresponding public key, presents numerous advantages over symmetric encryption based on a shared secret. By having the external entity sign messages with a unique private key and enabling the trusted application to verify these messages with the corresponding public key, it ensures that the sender cannot dispute the authenticity of their message, which is a concept known as non-repudiation. In contrast to symmetric encryption, where a shared secret is vulnerable to interception during exchange, the private key in digital signing based on asymmetric cryptographic keys remains safely undisclosed. Moreover, such digital signing allows for more straightforward key management, as entities only need to handle a pair of keys regardless of the system's size, enhancing scalability and reducing the complexity associated with managing a multitude of shared secrets. The open distribution of public keys further aids in the seamless establishment of secure communications across diverse systems without the cumbersome process of sharing and maintaining confidential keys. This openness also simplifies key revocation and rotation processes, allowing for swift responses to compromised keys without the need to revisit every shared secret. Additionally, public keys can be conveniently distributed via public channels or incorporated within digital certificates, streamlining key distribution and ensuring secure key establishment without the prerequisite of an existing secure channel. Asymmetric keys also fit well within established security frameworks, such as PKIs, which support key distribution and management and can be managed by the computerized backend resource BE. They offer the flexibility to both encrypt data and create digital signatures, unlike symmetric keys, which are typically limited to encryption only. Lastly, asymmetric systems provide cryptographic agility, making it easier to adapt or upgrade cryptographic algorithms without the logistical challenge of redistributing shared secrets to all users. Overall, asymmetric cryptography enhances the integrity and authenticity of interactions between external entities and trusted applications, especially in complex environments with numerous users or devices.

At 222, 224, the defined response message Issuer_Update_Resp, Sec_Update_Resp is sent back to the trusted application TA via the normal application NA. The response message Issuer_Update_Resp, Sec_Update_Resp comprises the signed response S2 and the response TBS2, similar to how the request Sec_Update_Req, Issuer_Update_Req was sent at 214, 216.

At 226, the trusted application TA receives and verifies the signed response S2 using the response TBS2 and the issuer certificate issuer_cert maintained by the trusted application TA. Optionally, the trusted application TA refreshes or modifies a chronological record with a new time based on the received timestamp timestamp2. Step 226 also involves a conditional check involving a calculation of the absolute value of the difference between the timestamp timestamp previously recorded by the trusted application and the timestamp for a receiving time of the response message Sec_Update_Req, Issuer_Update_Req. The difference represents the time elapsed between these two events (request event and response event). The absolute value of the time difference is then compared to a threshold time T, which is expressed in seconds. The threshold time T corresponds to a time that has passed since the generation of the request and the receiving of the response. If the absolute value of the time difference is less than the threshold time T, and if the first counter value req_id involves an expected value (e.g. it has not been unexpectedly incremented or decremented due to a fraudulent rollback attempt), then the trusted application TA is deemed to be operating within an acceptable time frame. The trusted application TA is accordingly “unlocked”, i.e., permitted to proceed with its operations.

The purpose of step 226 is to ensure that the response message is timely and relevant to the current state of the trusted application TA. The response thus includes information which enables verification by the trusted application TA that a present execution state within the trusted application TA is not older than a most recent execution state as recorded by the external entity (computerized backend resource BE). In case the present execution state within the trusted application TA is found to be older than a most recent execution state as recorded by the computerized backend resource BE, the computerized backend resource BE may prohibit further actions that operate upon the protected asset ta_asset. This is a security feature designed to prevent fraudulent rollback. By requiring the response message to be within a certain time window T of the trusted application's TA recorded timestamp and ensuring that the first counter value req_id matches, the integrity and authenticity of proceeding actions can be validated. Such proceeding actions are access control actions with respect to the protected asset ta_asset depending on an outcome of the verification.

In some examples, the host device HD is configured for executing the normal application NA in a normal execution environment NEE. The access control to the protected asset ta_asset in these examples involves admitting full usage thereof for the non-secure normal application when the verification was successful, and preventing any and all access usage thereof when the verification failed. A failed outcome of the verification thus results in a prevented access usage of the protected asset ta_asset. This may be done by not unlocking the trusted application TA, thereby making it impossible to access the protected asset ta_asset.

In other examples, the host device HD is configured for executing the normal application NA in a normal execution environment NEE. The access control to the protected asset ta_asset in these examples involves admitting full usage thereof for the non-secure normal application when the verification was successful, and admitting limited usage of the protected asset ta_asset thereof when the verification failed. In these examples it may be of interest to allow some access usage but not all. It might be the case that some aspects of the checks at 226 fail, but not all. Depending on what failures are realized then different access can be granted. For example, an evident indication of a fraudulent rollback event is arguably more severe compared to a request that fails with timing aspects such as a mismatch in timestamp data. In the examples relating to limited usage of the protected asset ta_asset, the type of limited usage can also vary from one access control to another.

One type of limited usage may involve admitting usage of the protected asset ta_asset during a time period. The time period can vary depending on the type of protected asset ta_asset, the type of application area, the security requirements of the prevailing system, network loads, resource requirement, a vulnerability class of the computer environment, or the like. By limiting access to predetermined time periods, the window of opportunity for unauthorized access or attacks is reduced, thus enhancing the overall security of the protected asset ta_asset. In addition, certain regulations may require that access to sensitive data be restricted to specific times for privacy or security reasons, and this approach can ensure adherence to such legal requirements. Moreover, providing access during a certain time period can allow for better management of operational workflows by ensuring that access to critical systems or data is available only when necessary, such as during business hours or scheduled maintenance times. Further, by restricting access to certain time periods, the risk of accidental changes or exposure of the protected asset ta_asset is minimized since fewer individuals or processes may have the opportunity to interact with it. Additionally, limiting access to certain times can optimize system resources by reducing the load on systems during off-peak hours, potentially improving performance during high-demand periods. Yet additionally, monitoring and auditing access events can become more manageable when access is confined to specific times, making it easier to review logs and detect anomalies relating to potential fraudulent rollbacks.

Another type of limited usage may involve admitting usage of the protected asset ta_asset for a maximum number of actions only. The maximum number of actions can vary depending on the type of protected asset ta_asset, the type of application area, the security requirements of the prevailing system, network loads, resource requirement, a vulnerability class of the computer environment, or the like. By restricting the number of actions, it can prevent excessive use on the protected asset ta_asset, which could be a computational capacity or physical resource. It can also assist in preventing abuse or misuse of the asset, such as in scenarios where unlimited access could lead to exploitation. For services incurring costs per transaction or interaction, controlling the number of actions can help manage and predict operational expenses. Moreover, the maximum number of actions can reduce potential attack surface, as malicious actors have fewer opportunities to attempt exploits or unauthorized access. Other such advantages can relate to traffic management, quality of service, and audit and compliance control.

In some examples, usage may be admitted for a first type of action but not for a second type of action. The second type of action may be different from the first type of action. This may be a useful access control procedure based on various factors, including but not limited to security levels (different types of actions may have varying security implications that are associated with high or low risks), operational necessity (some actions may be important for routine operations and thus allowed, while others can be omitted due to their non-critical nature), data sensitivity (certain actions involving access to sensitive or confidential information may be restricted to preserve privacy and comply with data protection regulations), user privileges (different user roles may have permissions tailored to their responsibilities, allowing them to perform certain actions but not others that are outside their purview), resource conservations (some actions may be resource-intensive and restricted to conserve system resources, while less demanding ones may be allowed), compliance requirements (regulatory or policy requirements can dictate that certain actions be tightly controlled due to legal, contractual or ethical considerations), system integrity (actions that could potentially alter system configurations or data integrity might be restricted to prevent accidental or malicious modifications). Other such factors can be envisaged.

The rollback procedure 200 which has now been explained to some extent may enhance security and integrity, in this case for financial transactions, with respect to rollback prevention. This setup may ensure that transaction histories are immutable and protected from tampering through secure audit trails and robust encryption. Strict access controls prevent unauthorized access, while independent verification of critical data safeguards against local system vulnerabilities. The use of counter values and conditional timestamp checks protects against replay attacks and unauthorized rollback attempts, contributing to the overall resilience of the transaction system.

In FIG. 3, the third entity of the procedure 300 is part of the host device HD. To this end, the rollback prevention functionality RP is comprised in the host device HD, corresponding to the embodiment shown in FIG. 1A. The external entity as discussed above is therefore in this example a secure element or optionally a secure execution environment SEE of the host device HD involving the rollback prevention functionality RP. Embodying the external entity as the secure element to prevent fraudulent rollback in a system may provide advantages in terms of reduced latency, enhanced control, and regulatory compliance. The host device HD may offer quicker transaction processing, robust access controls, and real-time monitoring, ultimately improving responsiveness and security. In addition, the autonomy of the host device HD may minimize exposure to external vulnerabilities and facilitate efficient implementation of encryption measures. While lacking the redundancy and other security measures provided by the computerized backend resource BE of the example of FIG. 2, this approach may be suitable for scenarios prioritizing low-latency, locality, and compliance with local processing requirements.

At 302, 304, 306, various data to be used for the procedure 300 are shown. These may be set during initiation of the procedure 300, and/or were optionally set at a previous operation.

Seen at 302 is data maintained by the trusted application TA. In addition to the data at 202 of FIG. 2, the data of step 302 further includes a root certificate os_root_cert of the operating system running the trusted application TA. The operating system root certificate os_root_cert establishes a chain of trust for security performing operations within the system, particularly those involving communication with other entities. In a security protocol involving communication only with an internal rollback prevention functionality RP, as is the case for the flowchart example of FIG. 3, the operating system root certificate os_root_cert is used to establish trust within the host system. Since all operations are internal and the trust boundaries do not extend beyond the system itself, the operating system root certificate os_root_cert acts as the ultimate authority, ensuring the integrity and trustworthiness of components within the system. This internal certificate validates the authenticity of software components, enforces security policies, and establishes secure communication channels within the host device. On the other hand, a security protocol involving communication with an external rollback prevention functionality, such as one maintained by the computerized backend resource BE of the flowchart example of FIG. 2, does not necessarily rely on the operating system root certificate os_root_cert because the trust model extends beyond the local system. Instead, the computerized backend resource BE often has its own set of security measures and may use different certificates issued by a CA that both the computerized backend resource and the host device HD trust.

At 304 a similar user alias user_alias as was established in step 204 is shown.

At 306, data used by the rollback prevention functionality RP is shown. It shall be noted that the notion of “se” among this data stands for secure element, which has been discussed herein. The data includes a private key for the host device device_se_priv_key used for creating digital signatures and decrypting data. The data includes a certificate for the host device device_se_cert which is a digital certificate associating the public key of the secure element with the host device HD and is used by third parties to verify the authenticity of the host device HD and the integrity of the signatures created by the corresponding private key device_se_priv_key. The data also includes a second counter se_sign_counter, which shares a similar functionality as the second counter issuer_user_alias_counter described with reference to FIG. 2. It shall also be noted that the rollback prevention functionality RP included in the host device HD does not necessarily need to maintain a user database as were the case in the example of FIG. 2 because of its locality.

Steps 308, 310, 312 are similar to the corresponding steps 208, 210, 212 of FIG. 2, as are steps 214, 216 with the difference that this, in the present example, is communicated internally rather than via outgoing communication peripherals to backend resources. Therefore, the request Sec_Update_Req, Device_SE_Sign_Req need not be communicated externally to the host device HD. Note that “externally to the host device HD” is not the same definition as the “external entity”. The external entity merely refers to the fact that it is external from a computerized module of the trusted application TA. The rollback functionality RP is accordingly in this case also provided by an “external entity”, but nevertheless provided internally with respect to the host device HD.

At 318, the second counter se_sign_counter is incremented by one, and the message to be signed TBS2 is defined and signed into S2 using the private key of the host device device_se_priv_key. Distinct from the corresponding step 318 of FIG. 2, the step 318 further involves including the second counter se_sign_counter in the response Device_SE_Sign_Resp, Sec_Update_Resp to the trusted application TA.

The response message Device_SE_Sign_Resp, Sec_Update_Resp is sent to the trusted application TA at 320, 322.

At 324, several different actions are made to complete the rollback prevention procedure 300. The operating system root certificate os_root_cert is used to confirm the authenticity and integrity of the certificate of the host device device_se_cert, ensuring it has been issued by a trusted authority and has not been tampered with. The signature of the signed response S2 is then verified against the certificate of the host device device_se_cert and the response TBS2, confirming that the response message Sec_Update_Resp, Device_SE_Sign_Resp originated from the secure element and has not been altered. A subsequent operation involves checking whether the first counter req_id matches the second counter se_sign_counter of the response TBS2. Then the signed request S is checked using the public key of the trusted application ta_pub_key against the request TBS to confirm it was indeed signed by the private key of the trusted application ta_priv_key and is therefore authentic. After verifying that the initial checks are successful, the next step is to determine whether the value of the first counter req_id is greater than or equal to the value of the second counter se_sign_counter. This should indeed be the case, otherwise there may be a risk of a fraudulent rollback having occurred. This is accordingly a verification that the present execution state within the trusted application TA is not older than the most recent execution state as recorded by the secure element. A similar timestamp checking procedure that was conducted at 226 of FIG. 2 can then optionally be carried out (as seen in FIG. 3), followed by an unlocking of the trusted application allowing it to proceed with its intended secure operations. This is done provided that all subsequent checks of 324 are successful, thereby indicating that the request obtained is authentic, timely, and in correct sequence without a risk of fraudulent rollback activity.

In response to passing step 324, subsequent access control procedures generally according to what was discussed above in relation to FIG. 1 can be envisaged similarly.

FIG. 4 illustrates a digital payment system 400 allowing payers to make digital payments to payees. As mere examples, the digital cash transfer system 400 in FIG. 4 comprises a mobile communication device 420 for use by a payer P1 and a point-of sales terminal 450 operated by a payee P2. The mobile communication device 420 may be a host device HD as referred to above for the preceding drawings.

The mobile communication device 420 has an interface WAN I/F for wide area network data communication via a wide area network 410, as well as an interface S-R I/F for short-range wireless data communication. Moreover, the mobile communication device 420 has a processing device Cr that serves as a controller of the mobile communication device 420 and that may be implemented in any known controller technology, including but not limited to microcontroller, processor (e.g. PLC, CPU, DSP), FPGA, ASIC or any other suitable digital and/or analog circuitry capable of performing the intended functionality. The mobile communication device 420 further has a memory Mem that may be implemented in any known memory technology, including but not limited to ROM, RAM, SRAM, DRAM, CMOS, FLASH, DDR, SDRAM, SSD or magnetic hard disk, or some other memory technology. In some embodiments, the memory or parts thereof may be integrated with or internal to the processing device Ctrl. The memory Mem may store program instruction for execution by the processing device Ctrl, as well as temporary and permanent data for use by the processing device Ctrl.

The mobile communication device 420 has a user interface UI, as is commonplace in the art. The user interface UI comprise an input device and a presentation device. The input device and the presentation device may be constituted by one common physical device, such as for instance a touch screen (touch-sensitive display screen), implemented in for instance resistive touch technology, surface capacitive technology, projected capacitive technology, surface acoustic wave technology or infrared technology.

As has been explained above, the mobile communication device 420 is configured for enabling the payer P1 to make digital payments by any or all of the available communication channels, i.e. using any or all of the wide area network data communication (cf. interface WAN I/F) and short-range wireless data communication (cf. interface S-R I/F).

The short-range data communication interface S-R I/F may be configured for Bluetooth communication, or any other radio-based short-range wireless data communication such as, for instance, Bluetooth Low Energy, RFID, WLAN, WiFi, mesh communication or LTE Direct, without limitation, or any non-radio-based short-range wireless data communication such as, for instance, magnetic/inductive communication (such as NFC), (ultra)sound communication, or optical communication (such as IrDA) without limitation. In some embodiments, the short-range data communication interface S-R I/F comprises equipment and functionality for presenting and/or scanning a QR code.

The wide area network communication interface WAN I/F may be configured for wide area network communication compliant with, for instance, one or more of W-CDMA, GSM, UTRAN, HSPA, LTE, LTE Advanced or 5G, and TCP/IP, and/or WLAN (WiFi), without limitation.

To support digital payments, the mobile communication device 420 has a secure digital wallet, implemented as a trusted application TA executable in a secure execution environment, SEE, as described above. The mobile communication device 420 will typically also have a payment application executing as a normal application NA (cf. the preceding description with reference to FIGS. 1A-B). The payer P1 may interact through the user interface UI with the payment application (not shown in FIG. 4) to use a payment application service provided by a payment service provider PSP or a bank service BS1 . . . BSn.

Through the payment application, the payer P1 can make digital payments from the secure digital wallet/trusted application TA as online payments 470 by communicating with other entities like a point-of sales, POS, terminal 430, another mobile communication device, MCD, 440, or directly with a payment service provider PSP that provides a payment application service. Such digital payment are online in the sense that the performance thereof will involve instant communication with cloud-based resources like the payment service provider PSP, bank services BS1 . . . BSn, etc., for payment verification, clearing and settlement.

The payer P1 can furthermore make digital payments from the secure digital wallet/trusted application TA as offline payments 480 by short-range wireless communication with another nearby device (exemplified as a point-of-sales terminal 450) when being in physical proximity 460. Unlike the online digital payments 470, the offline digital payment 480 does not require momentary access to any of the cloud-based resources PSP, BS1 . . . BSn at the time of making the offline digital payment. The offline digital payment may be buffered at the point-of-sales terminal 450 (and/or the mobile communication device 420) and subsequently communicated to the cloud-based resources PSP, BS1 . . . BSn when communication over the WAN 410 is available. This is indicated by a broken line between the POS 450 and WAN 410 in FIG. 4.

Every offline digital payment of the payer P1 (as well as every online digital payment unless being made by directly charging an account of the payer P1 held at any of the cloud-based resources PSP, BS1 . . . BSn) will be made against a local balance ta_asset of the secure digital wallet/trusted application TA in the mobile communication device 420. Hence, the local balance ta_asset is an example of a protected asset of the trusted application TA.

Typically, the local balance ta_asset will be reduced by an amount identical to or at least corresponding to the payment amount of the digital payment made. When the local balance ta_asset has been consumed, the payer P1 may make a replenishment by requesting a top-up of the secure digital wallet at the cloud-based resources PSP, BS1 . . . BSn. Examples of protected functionality of the trusted application TA are, hence, the procedures for reducing the local balance ta_asset at offline digital payment and for topping-up the secure digital wallet.

However, and needless to say, if the secure digital wallet/trusted application TA were allowed to execute in a roll-backed execution state in the mobile communication device 420, there could be highly undesired situations of double-spending. This is particularly so for offline digital payments 480, since there is no online payment verification being made at the time of offline payment. The present invention presents advantageous fraud-prevention measures in this regard.

Some non-limiting examples of suitable technology for digital payments are described in the present applicant's PCT applications PCT/SE2020/051251, PCT/SE2021/050556, PCT/SE2022/050090 and PCT/SE2022/050152, as well as Swedish applications SE 2151401-3 and SE 2250076-3.

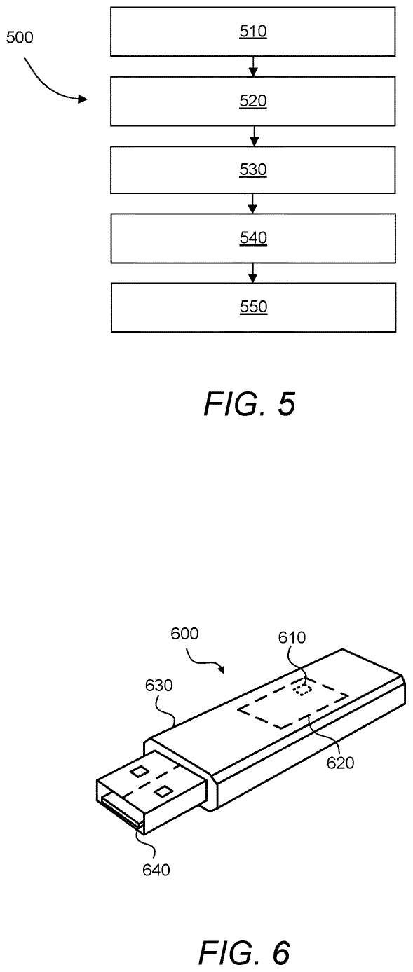

FIG. 5 is a schematic block diagram of a method 500 for preventing fraudulent rollback of a trusted application executable in a secure execution environment of a host device, the trusted application comprising a protected asset. The method 500 comprises repeatedly recording 510 an execution state of the trusted application within the trusted application, the execution state being a monotonic function of execution progress of the trusted application. The method 500 further comprises repeatedly causing 520 recording of the execution state in an entity external to the trusted application. The method 500 further comprises, upon occurrence of an event in the trusted application, sending 530 a request to said external entity. The method 500 further comprises receiving a response to said request from said external entity, the response including information which enables verification by the trusted application that a present execution state within the trusted application is not older than a most recently execution state as recorded by the external entity. The method 500 further comprises controlling access to the protected asset depending on an outcome of the verification, wherein the external entity signs the response to the trusted application with a private cryptographic key kept secret by the external entity, and wherein the trusted application verifies the signature of the response using a public cryptographic key corresponding to the private cryptographic key as part of the verification by the trusted application.

FIG. 6 is a schematic illustration of a non-transitory computer-readable storage medium 600 in one exemplary embodiment, capable of storing a computer program product 610. The non-transitory computer-readable storage medium 600 in the disclosed embodiment is a memory stick, such as a Universal Serial Bus (USB) stick; the non-transitory computer-readable storage medium 600 may however be embodied in various other ways instead, as is well-known per se to the skilled person. The USB stick 600 comprises a housing 630 having an interface, such as a connector 640, and a memory chip 620. In the disclosed embodiment, the memory chip 620 is a flash memory, i.e. a non-volatile data storage that can be electrically erased and re-programmed. The memory chip 620 stores the computer program product 610 which is programmed with computer program code (instructions) that when loaded into a processing device, such as a CPU, will perform a method for handling a digital payment according to any or all of the embodiments disclosed above. The processing device may, for instance, be the aforementioned processing device Ctrl. The USB stick 600 is arranged to be connected to and read by a reading device for loading the instructions into the processing device. It should be noted that a non-transitory computer-readable storage medium can also be other media such as compact discs, digital video discs, hard drives or other memory technologies commonly used. The computer program code (instructions) can also be downloaded from the non-transitory computer-readable storage medium via a wireless interface to be loaded into the processing device.

In one embodiment, therefore, the computer program product 610 comprises computer code for performing the functionality of the host device HD in the method 500 as described herein when the computer program code is executed by the processing device. In another embodiment, the computer program product 610 comprises computer code for performing the functionality of the computerized backend resource BE in the method 500 as described herein when the computer program code is executed by the processing device. In still another embodiment, the computer program product 610 comprises computer code for performing the functionality of the trusted application TA in the method 500 as described herein when the computer program code is executed by the processing device.

The invention has mainly been described above with reference to a few embodiments. However, as is readily appreciated by a person skilled in the art, other embodiments than the ones disclosed above are equally possible within the scope of the invention, as defined by the appended patent claims.

1. A method of preventing fraudulent rollback of a trusted application executable in a secure execution environment of a host device, the trusted application comprising a protected asset, the method involving:
repeatedly recording an execution state of the trusted application within the trusted application, the execution state being a monotonic function of execution progress of the trusted application;
repeatedly causing recording of the execution state in an entity external to the trusted application;
upon occurrence of an event in the trusted application, sending a request to said external entity;
receiving a response to said request from said external entity, the response including information which enables verification by the trusted application that a present execution state within the trusted application is not older than a most recent execution state as recorded by the external entity; and
controlling access to the protected asset depending on an outcome of the verification,
wherein the external entity signs the response to the trusted application with a private cryptographic key kept secret by the external entity, and
wherein the trusted application verifies the signature of the response using a public cryptographic key corresponding to the private cryptographic key as part of the verification by the trusted application.

2. The method of claim 1,
wherein the trusted application signs the request to the external entity with a private cryptographic key kept secret by the trusted application, and
wherein the external entity verifies the signature of the request using a public cryptographic key corresponding to the private cryptographic key as a requisite for sending the response to the trusted application.

3. The method of claim 1, wherein the fraudulent rollback prevented by the method is re-use of the protected asset for a specific action already performed once before.

4. The method of claim 1, the host device being configured for executing a non-secure normal application in a non-secure normal execution environment, wherein controlling access to the protected asset involves admitting full usage of the protected asset for the non-secure normal application when the verification was successful and preventing any and all access usage of the protected asset for the non-secure normal application when the verification failed.

5. The method of claim 1, the host device being configured for executing a non-secure normal application in a non-secure normal execution environment, wherein controlling access to the protected asset involves admitting full usage of the protected asset for the non-secure normal application when the verification was successful and admitting limited usage of the protected asset for the non-secure normal application when the verification failed.

6. The method of claim 5, wherein admitting limited usage of the protected asset for the non-secure normal application when the verification failed includes admitting usage of the protected asset during a time period.

7. The method of claim 5, wherein admitting limited usage of the protected asset for the non-secure normal application when the verification failed includes admitting usage of the protected asset for a maximum number of actions only.

8. The method of claim 6, wherein admitting limited usage of the protected asset for the non-secure normal application when the verification failed includes admitting usage of the protected asset for a first type of action but not for a second type of action.

9. The method of claim 1,
wherein repeatedly recording the execution state of the trusted application within the trusted application involves incrementing a first counter maintained by the trusted application, and
wherein repeatedly causing recording of the execution state in the external entity involves causing incrementing of a second counter maintained by the external entity.

10. The method of claim 9,
wherein the first counter is incremented in preparation of the sending of the request to said external entity, and
wherein the second counter is incremented between the receiving of the request and the sending of the response by said external entity.

11. The method of claim 9,
wherein the first counter is included in the request to the external entity, and
wherein the second counter is included in the response to the trusted application and used by the trusted application to verify that the first counter is higher than the second counter and that, accordingly, the present execution state within the trusted application is not older than the most recent execution state as recorded by the external entity.

12. The method of claim 9,
wherein the first counter is included in the request to the external entity, and
wherein the second counter is used by the external entity to verify that the first counter is higher than the second counter and that, accordingly, the present execution state within the trusted application is not older than the most recent execution state as recorded by the external entity.

13. The method of claim 1,
wherein a timestamp is included by the trusted application in the request to the external entity,
wherein the timestamp is included in the response by said external entity, and
wherein the verification by the trusted application includes checking that the timestamp in the response indicates that no more than a threshold time has passed since the generation of the request and the receiving of the response.

14. The method of claim 1, wherein the external entity is a host device comprising protected hardware resources.

15. The method of claim 1, wherein the external entity is a computerized backend resource being connectable with the host device over one or more communication networks.

16. The method of claim 15, wherein the sending of the request to the computerized backend resource and the receiving of the response from said computerized backend resource involves circuit-switched telecommunication.

17. The method of claim 16, wherein the trusted application supports actions that operate upon the protected asset and involves packet-switched wide area network communication with the computerized backend resource.

18. The method of claim 15, wherein, in case the present execution state within the trusted application is found to be older than a most recent execution state as recorded by the computerized backend resource, the computerized backend resource prohibits further actions that operate upon the protected asset.

19. The method of claim 1, wherein said event in the trusted application is any of the following:
a rebooting of the host device;
a request for an action that operates upon the protected asset;
an occurrence of a scheduled event; and
a randomized occurrence of an event.

20. The method of claim 1, wherein the secure execution environment is a software-based virtual execution environment, and wherein the protected asset is maintained in protected hardware resources accessible to the trusted application when executed in the software-based virtual execution environment.

21. The method of claim 1, wherein the protected asset represents a finite digital resource, such as a service subscription or a license scheme.

22. The method of claim 1, wherein the trusted application is a secure digital wallet for a payment application service and the protected asset represents a balance of the secure digital wallet.

23. The method of claim 22, wherein the trusted application supports offline digital payments communicated by short-range wireless communication between the host device acting as a payer device and an external communication device acting as a payee device.

24. A host device comprising a secure execution environment (SEE) for executing a trusted application, the trusted application comprising a protected asset, the host device being configured to prevent fraudulent rollback of the trusted application by performing the functionality of the method of claim 1.

25. (canceled)

26. A trusted application comprising computer program code being executable in a secure execution environment of a host device, the trusted application comprising a protected asset and being configured to prevent fraudulent rollback by performing the functionality of the trusted application in the method of claim 1.

27. (canceled)

28. A computerized backend resource for preventing fraudulent rollback of a trusted application executable in a secure execution environment of a host device, the trusted application comprising a protected asset, the computerized backend resource being configured to perform the functionality of the computerized backend resource in the method according to claim 15.

29. (canceled)

30. A non-transitory computer readable storage medium having stored thereon a computer program comprising computer program code for performing the functionality of the host device in the method of claim 1 when the computer program code is executed by a processing device.

31. A non-transitory computer readable storage medium having stored thereon a computer program comprising computer program code for performing the functionality of the trusted application in the method of claim 1 when the computer program code is executed by a processing device.

32. A non-transitory computer readable storage medium having stored thereon a computer program comprising computer program code for performing the functionality of the computerized backend resource in the method of claim 15 when the computer program code is executed by a processing device.
